(19) United States
(12) Patent Application Publication
(10) Pub. No.: US 2018/0229079 A1
(43) Pub. Date: Aug. 16, 2018

(54) DATA PROCESSING METHOD, PROGRAM, STORAGE MEDIUM AND MOTION ANALYSIS DEVICE

(71) Applicant: SEIKO EPSON CORPORATION, Tokyo (JP)

(72) Inventors: Tsuyoshi Ito, Suwa-shi (JP); Kenya Kodaira, Azumino-shi (JP)

(73) Assignee: SEIKO EPSON CORPORATION, Tokyo (JP)

(21) Appl. No.: 15/890,772

(22) Filed: Feb. 7, 2018

(30) Foreign Application Priority Data
Feb. 14, 2017 (JP) 2017-024694

(51) Int. Cl. A63B 24/00; A63B 71/06; A63B 60/46; A63B 69/36; G06K 9/00

(52) U.S. Cl. CPC A63B 24/0006; A63B 71/0622; A63B 60/46; A63B 69/3632; A63B 2024/0012; A63B 2225/50; A63B 2220/803; A63B 2024/0009; G06K 9/00342

(57) ABSTRACT

A data processing method in a motion analysis system including a storage region (information processing device) storing motion data of a user and position information related to the motion data, includes acquiring position information of the user, searching for past motion data in a predetermined position range from the acquired position information, and outputting advice information on the basis of the past motion data.

This application claims priority from Japanese patent application JP 2017-024694 filed Feb. 14, 2017, which is incorporated herein by reference in its entirety.

### BACKGROUND

### 1. Technical Field

The present invention relates to a data processing method, a program, a storage medium and a motion analysis device for processing, for example, motion data of a user or position information or the like related to the motion data.

### 2. Related Art

In the related art, for example, as an analysis method of analyzing a motion such as a swing in golf, an analysis method is proposed in which a motion of a user is analyzed on the basis of data output from an inertial sensor attached to the user or, for example, an exercise appliance such as a golf club, or data captured by an imaging device (for example, refer to JP-A-2012-31529 or JP-A-2013-9771).

However, the motion analysis method of the related art is an analysis method based on data related to a motion of a user, and thus the influence of a surrounding environment of the user, for example, a round position in golf is not taken into consideration. Thus, even if motion analysis information (analysis result) is applied to advice, the result (advice) may not satisfy the user.

### SUMMARY

An advantage of some aspects of the invention is to solve at least a part of the problems described above, and the invention can be implemented as the following forms or application examples.

### Application Example 1

A data processing method according to this application example is a data processing method in a motion analysis system including a storage region storing motion data of a user and position information related to the motion data, the data processing method including acquiring position information of the user; searching for past motion data in a predetermined position range on the basis of the acquired position information; and outputting advice information on the basis of the past motion data.

According to the data processing method of this application example, advice information such as a tendency of past motion data in a predetermined position range which is retrieved and extracted from motion information (motion data of a user and position information related to the motion data) accumulated in the storage region is output on the basis of position information of the user. Consequently, analysis information including information indicating a general tendency of the past motion data related to the current position in a motion at the current position of the user can be presented to the user. Therefore, the user can perform a motion while making a strategy on the basis of information indicating the general tendency, and can thus obtain an analysis result (advice information) which is more satisfactory.

### Application Example 2

In the data processing method according to the application example, it is preferable that the motion data is motion data of a plurality of different users.

According to this application example, advice information in a predetermined position range is output on the basis of stored motion data of a plurality of different users. Consequently, it is possible to increase the reliability of analysis information including information indicating a general tendency of the past motion data related to the current position presented to the user.

### Application Example 3

In the data processing method according to the application example, it is preferable that the motion data is motion analysis information related to golf, and the position information is position data related to a round of golf.

According to this application example, a tendency of the past motion analysis information in a predetermined position range which is retrieved and extracted from motion analysis information (golf swing analysis data) accumulated in the storage region is output on the basis of position information of the user related to a round of golf. Consequently, it is possible to present advice information including information indicating a general tendency of the past motion analysis information related to the current position at the time of a shot at the current round position of the user, to the user. Therefore, the user can perform rounding while making a strategy on the basis of the advice information indicating the general tendency, and can obtain an analysis result (advice information) related to a golf swing, which is more satisfactory.

### Application Example 4

It is preferable that the data processing method according to the application example further includes receiving a golf level, and, in the outputting of the advice information, a tendency of the motion analysis information corresponding to the golf level is output.

According to this application example, the user can obtain a tendency of motion analysis information corresponding to the same extent of golf ability level as that of the user. In other words, the user can obtain a more accurate analysis result (advice information) related to a golf swing, suitable for the golf level of the user.

The golf level here may be expressed as the ability of a player classified on the basis of, for example, a score level. For example, a person of which a handicap is equal to or less than a single is classified as a “person with advanced skills”, a person of which a score average is 80 to 90 is classified as an “intermediate”, a person of which a score average is 90 to below 100 is classified as a “beginner”, and a person of which a score average is equal to or more than 100 is classified as a “newcomer”.

### Application Example 5

In the data processing method according to the application example, it is preferable that the advice information is related to at least one of a carry of a hit ball, a target direction, and golf club information in golf.

The user can obtain advice information related to at least any of a carry of a hit ball, a target direction, and golf club information in golf, and can thus obtain more detailed and accurate advice information of a swing at the current position.

### Application Example 6

A program according to this application example is a program related to data processing in a motion analysis system including a storage region storing motion data of a user and position information related to the motion data, the program causing a computer to execute acquiring position information of the user; searching for past motion data in a predetermined position range on the basis of the acquired position information; and outputting advice information on the basis of the past motion data.

According to the program of this application example, advice information such as a tendency of past motion data in a predetermined position range which is retrieved and extracted from motion information (motion data of a user and position information related to the motion data) accumulated in the storage region is output on the basis of position information of the user. Analysis information including information indicating a general tendency of the past motion data related to the current position in a motion at the current position of the user can be presented to the user. Therefore, the user can perform a motion while making a strategy on the basis of information indicating the general tendency, and can thus obtain an analysis result (advice information) which is more satisfactory.

### Application Example 7

A storage medium according to this application example stores a program related to data processing in a motion analysis system including a storage region storing motion data of a user and position information related to the motion data, the program causing a computer to execute acquiring position information of the user; searching for past motion data in a predetermined position range on the basis of the acquired position information; and outputting advice information on the basis of the past motion data.

According to the storage medium of this application example, it is possible to cause a computer to execute the program for outputting advice information in a predetermined position range which is retrieved and extracted from motion information (motion data of a user and position information related to the motion data) accumulated in the storage region on the basis of position information of the user. Consequently, analysis information including information indicating a general tendency of the past motion data related to the current position in a motion at the current position of the user can be presented to the user. Therefore, the user can perform a motion while making a strategy on the basis of information indicating the general tendency, and can thus obtain an satisfactory.

### Application Example 8

A motion analysis device according to this application example is a motion analysis device which acquires motion data of a user, position information related to the motion data, and position information of the user, and outputs advice information on the basis of past motion data in a predetermined position range based on the position information of the user.

According to the motion analysis device of this application example, it is possible to output advice information in a predetermined position range which is retrieved and extracted from motion information (motion data of a user and position information related to the motion data) on the basis of position information of the user. Consequently, analysis information including information indicating a general tendency of the past motion data related to the current position in a motion at the current position of the user can be presented to the user. Therefore, the user can perform a motion while making a strategy on the basis of information indicating the general tendency, and can thus obtain an analysis result (advice information) which is more satisfactory.

### Application Example 9

It is preferable that the motion analysis device according to the application example outputs course information and the advice information on the basis of position information of the user.

According to this application example, the advice information and the course information can be presented, and thus the user can check the advice information while referring to the course information. Consequently, the user can understand the advice information well.

### BRIEF DESCRIPTION OF THE DRAWINGS

The invention will be described with reference to the accompanying drawings, wherein like numbers reference like elements.

FIG. 1 is a diagram illustrating a configuration example of a motion analysis system according to the present embodiment.

FIG. 2 is a diagram illustrating a sensor unit and a swing analysis device.

FIG. 3 is a diagram illustrating examples of a position at which and a direction in which the sensor unit is attached.

FIG. 4 is a diagram illustrating procedures of actions performed by a user until the user hits a ball.

FIG. 5 is a diagram illustrating a swing action.

FIG. 6 is a diagram illustrating configuration examples of the sensor unit and a swing analysis device.

FIG. 7 is a flowchart illustrating steps related to Embodiment 1 of a data processing method in the motion analysis system.

FIG. 8 is a block diagram for explaining advice items regarding a tendency of the past motion data.

FIG. 9A is a diagram illustrating an advice display example 1 of giving advice on a tendency of the past motion data related to the current position.

FIG. 9B is a diagram illustrating an advice display example 2 of giving advice on a tendency of the past motion data related to the current position.

FIG. 10 is a flowchart illustrating steps related to Embodiment 2 of a data processing method in the motion analysis system.

FIG. 11 is a diagram illustrating a classification example of a golf level.

### DESCRIPTION OF EXEMPLARY EMBODIMENTS

Hereinafter, preferred embodiments of the invention will be described with reference to the drawings. The embodiments described below are not intended to improperly limit the content of the invention disclosed in the appended claims. In addition, all constituent elements described below are not essential constituent elements of the invention.

### 1. Motion Analysis System

### 1-1. Configuration of Motion Analysis System

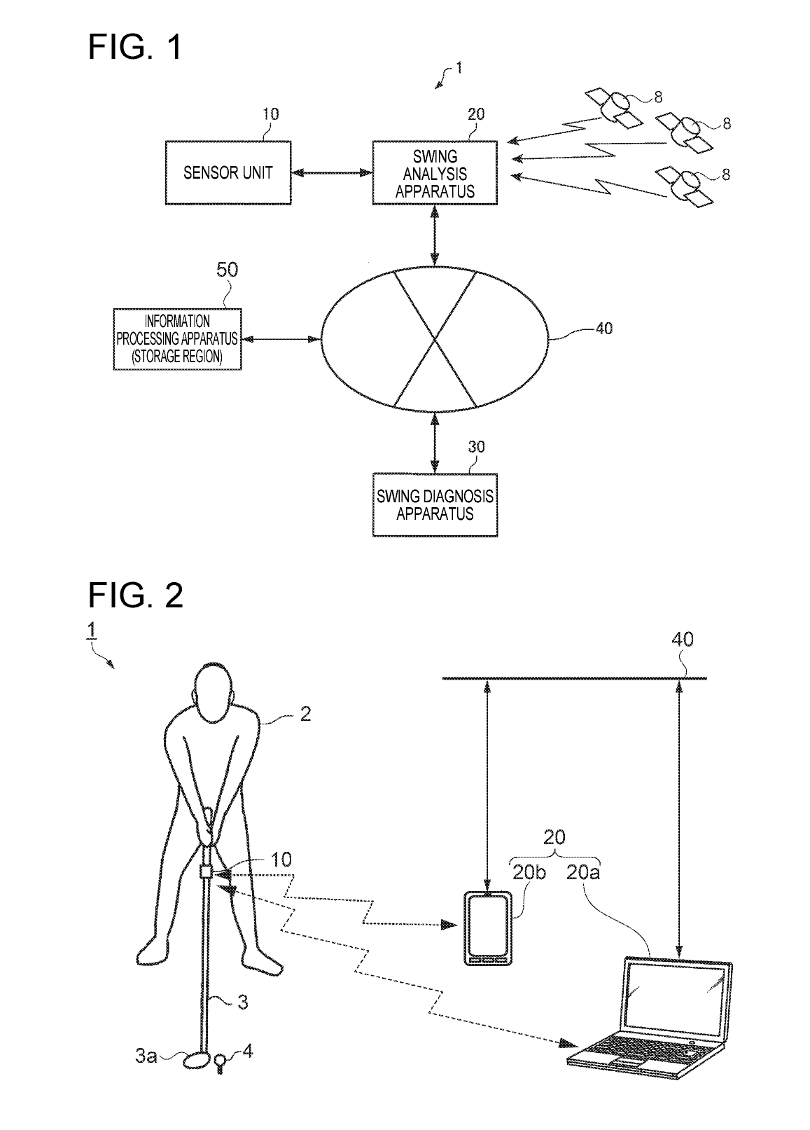

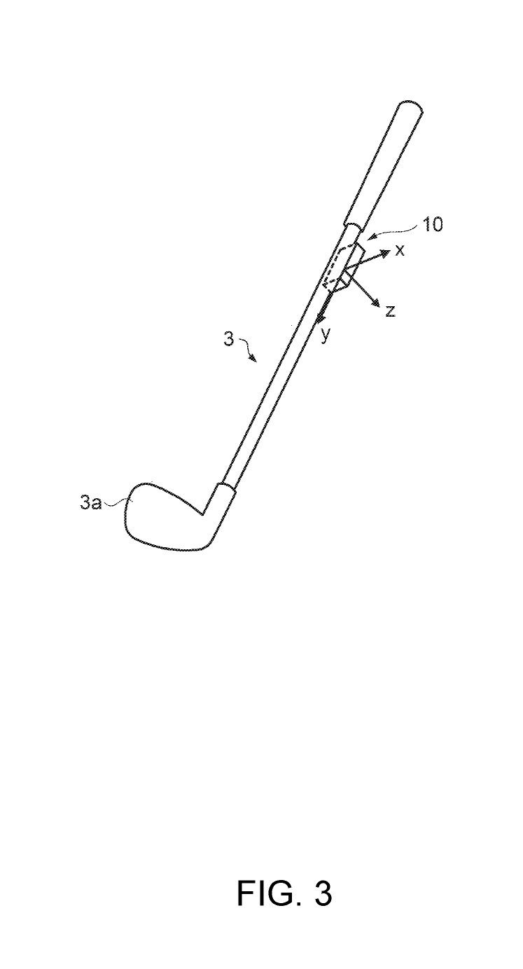

Hereinafter, with reference to FIGS. 1, 2 and 3, a motion analysis system will be described by using analysis of a swing in golf (hereinafter, referred to as a golf swing) as an example of motion analysis. FIG. 1 is a diagram illustrating a configuration example of the motion analysis system according to the present embodiment. FIG. 2 is a diagram illustrating a sensor unit and a swing analysis device. FIG. 3 is a diagram illustrating examples of a position at which and a direction in which the sensor unit is attached.

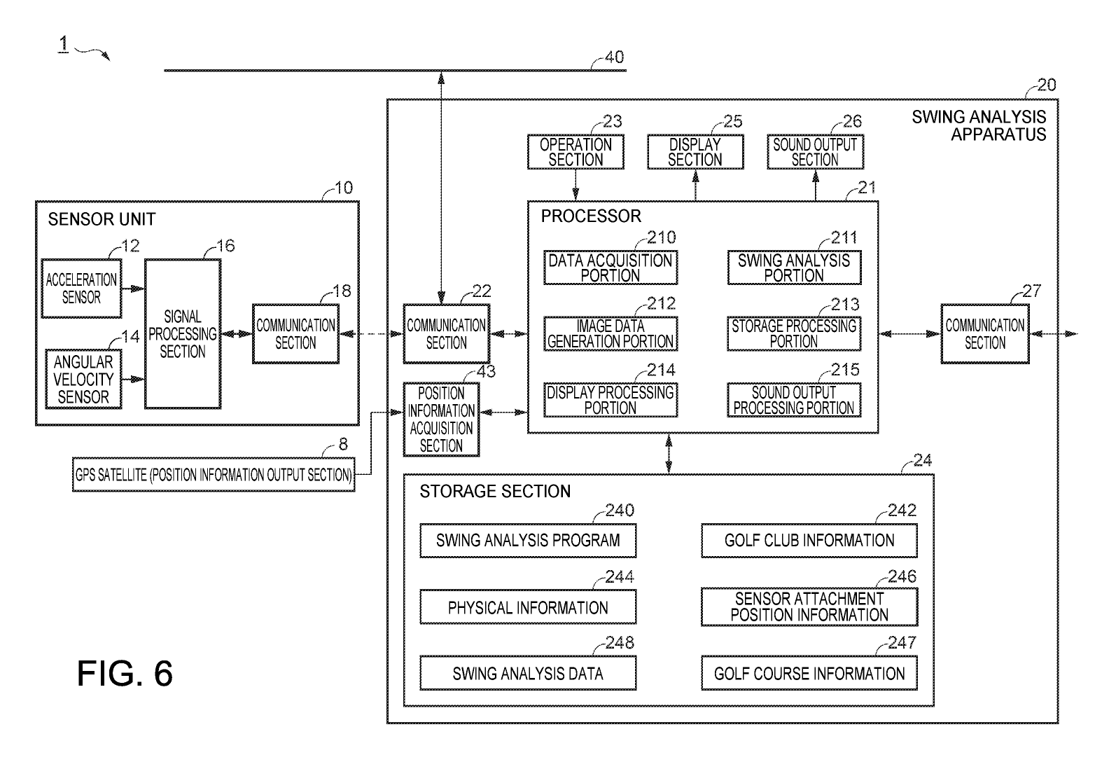

As illustrated in FIG. 1, a motion analysis system 1 of the present embodiment includes a sensor unit (an example of an inertial sensor) 10, a swing analysis device (an example of a motion analysis device) 20, and an information processing device 50. The swing analysis device 20 may include a position information acquisition section 43 (refer to FIG. 6) having a function of receiving electric waves (satellite signals) from GPS satellites (position information output sections) 8, and performing positioning computation (acquisition of position information) on the basis of the position information included in the electric waves (satellite signals) from the GPS satellites 8. Communication between the sensor unit 10 and the swing analysis device 20 may be wireless communication, and may be wired communication. As illustrated in FIG. 2, the swing analysis device 20 is implemented by various information terminals (client terminals) including not only a personal computer 20a, but also a portable device 20b such as a smart phone or a tablet PC, or a wearable terminal such as head mounted display (HMD) or a wrist device.

The motion analysis system 1 may be configured to include a swing diagnosis device 30 separately from the swing analysis device 20. However, the swing diagnosis device 30 may be included in the swing analysis device 20. The swing diagnosis device 30 may be implemented by a server which processes a request from the swing analysis device 20. The swing analysis device 20 and the swing diagnosis device 30 may be connected to each other via a network 40. The network 40 may be a wide area network (WAN) such as the Internet, and may be a local area network (LAN). The swing analysis device 20 and the swing diagnosis device 30 may communicate with each other through, for example, near field communication or wired communication, without using the network 40.

The swing analysis device 20 may be connected to the information processing device 50 such as a personal computer (PC) or a server system via the network 40, or through short-range wireless communication or wired communication. In this case, the information processing device 50 may function as a storage region which receives motion data of a user 2 or position information or the like related to the motion data transmitted from the swing analysis device 20 via the network 40, and stores the data or the position information. The motion data stored in the information processing device 50 may include measured data (including raw data) which is measured by the sensor unit 10 or motion data (swing information including swing analysis information as motion analysis information) of the user 2 analyzed by the swing analysis device 20.

The motion analysis system 1 is not limited to being realized by the information processing device 50. For example, the motion analysis system 1 may be realized by the swing analysis device 20. For example, the swing analysis device 20 formed of a portable terminal device such as a smart phone has restriction in processing performance, a storage region, or a battery capacity compared with the server system in many cases, but may secure sufficient processing performance or the like in consideration of recent performance improvement. Therefore, if the needs for the processing performance or the like are satisfied, the swing analysis device 20 may be used as the motion analysis system 1 according to the present embodiment.

The motion analysis system 1 according to the present embodiment is not limited to be realized by a single device. For example, the motion analysis system 1 may include two or more devices among the swing analysis device 20, the swing diagnosis device 30, and the information processing device 50. In this case, a process performed by the motion analysis system 1 may be performed by any one device, and may be distributed to a plurality of devices so as to be performed. The motion analysis system 1 according to the present embodiment may include devices which are different from the swing analysis device 20, the swing diagnosis device 30, and the information processing device 50.

The sensor unit 10 can measure, for example, acceleration in each axial direction of three axes orthogonal to each other and, for example, angular velocity about each of the three axes orthogonal to each other, and is attached to, for example, a golf club 3 as an exercise appliance as illustrated in FIG. 2.

As illustrated in FIG. 3, the sensor unit 10 is attached to the golf club 3 (an example of an exercise appliance) so as to match three detection axes (an x axis, a y axis, and a z axis) intersecting (ideally, orthogonal to) each other. In FIG. 3, the sensor unit 10 is attached to a part of a shaft so that, for example, the y axis matches a longitudinal direction of the shaft of the golf club 3 (a longitudinal direction of the golf club 3), and, for example, the x axis matches a target direction of a hit ball (target hitting direction). Preferably, the sensor unit 10 is attached to a position close to a grip to which impact during ball hitting is hardly forwarded and a centrifugal force is not applied during a swing. The shaft is a shaft portion other than a head (ball hitting portion) 3a of the golf club 3 and also includes the grip. However, the sensor unit 10 may be attached to a part (for example, the hand or a glove) of the user 2, and may be attached to an accessory such as a wristwatch.

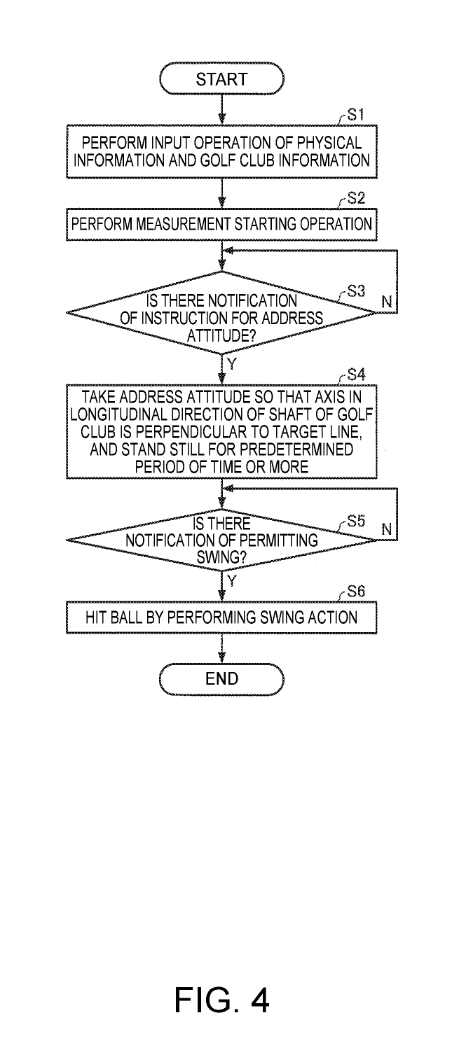

The user 2 performs a swing action for hitting a golf ball 4 or a swing action through a practice swing according to predefined procedures. FIG. 4 is a diagram illustrating procedures of actions performed by the user 2 until the user hits the ball in the present embodiment. As illustrated in FIG. 4, first, the user 2 performs an input operation of physical information of the user 2, information (golf club information) regarding the golf club 3 used by the user 2, and the like via the swing analysis device 20 (step S1).

In step S1 in FIG. 4, the user 2 inputs physical information such as a height, sex, age, and country, and inputs golf club information such as a club length (a length of the shaft), and a club number on an input screen (not illustrated). Information included in the physical information is not limited thereto, and, the physical information may include, for example, at least one of information regarding a length of the arms and a length of the legs instead of or along with the height. Similarly, information included in the golf club information is not limited thereto, and, for example, the golf club information may not include at least one of information regarding the club length and the club number, and may include other information.

Next, the user 2 performs a measurement starting operation (an operation for starting measurement in the sensor unit 10) via the swing analysis device 20 (step S2). After receiving a notification (for example, a notification using a voice) of giving an instruction for taking an address attitude (a basic attitude before starting a swing) from the swing analysis device 20 (Y in step S3), the user 2 takes an address attitude so that the axis in the longitudinal direction of the shaft of the golf club 3 is perpendicular to a target line (target hit ball direction), and stands still (step S4). Next, the user 2 receives a notification (for example, a notification using a voice) of permitting a swing from the swing analysis device 20 (Y in step S5), and then hits the golf ball 4 by performing a swing action (step S6). The present embodiment is not necessarily limited to ball hitting, and is also applicable to a practice swing, and may have a function of detecting a timing corresponding to ball hitting.

If the user 2 performs the measurement starting operation in step S2 in FIG. 4, the swing analysis device 20 transmits a measurement starting command to the sensor unit 10, and the sensor unit 10 receives the measurement starting command and starts measurement of three-axis accelerations and three-axis angular velocities. The sensor unit 10 measures three-axis accelerations and three-axis angular velocities in a predetermined cycle (for example, 1 ms), and sequentially transmits the measured data to the swing analysis device 20.

The swing analysis device 20 notifies the user 2 of permission of swing starting, shown in step S5 in FIG. 4, and then analyzes the swing action (step S6 in FIG. 4) in which the user 2 has hit the ball by using the golf club 3 on the basis of measured data from the sensor unit 10.

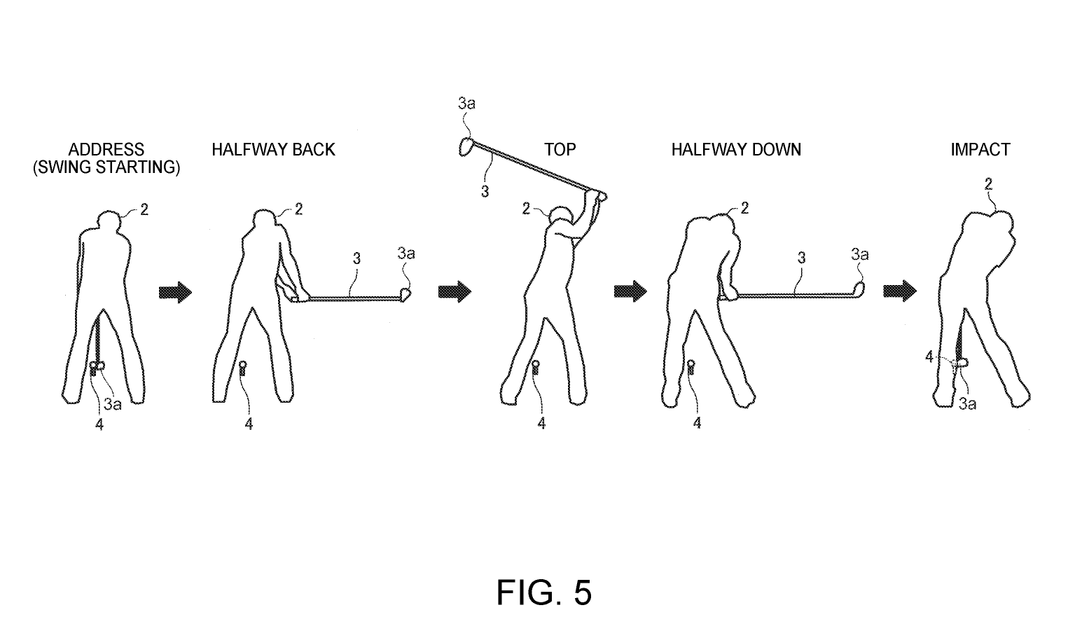

As illustrated in FIG. 5, the swing action performed by the user 2 in step S6 in FIG. 4 includes an action reaching impact (ball hitting) at which the golf ball 4 is hit from an address attitude (standing still state) through respective states of halfway back at which the shaft of the golf club 3 becomes horizontal during a backswing after starting a swing (backswing), a top at which the swing changes from the backswing to a downswing, and halfway down at which the shaft of the golf club 3 becomes horizontal during the downswing. The swing analysis device 20 generates swing analysis data including information regarding a time point (date and time) at which the swing is performed, identification information or the sex of the user 2, the type of golf club 3, and an analysis result of the swing action, and transmits the swing analysis data to the swing diagnosis device 30 and the information processing device 50 (refer to FIG. 1) functioning as a storage region via a network 40 (refer to FIG. 1).

The swing diagnosis device 30 receives the swing analysis data transmitted by the swing analysis device 20 and including motion data (swing information including swing analysis information as motion analysis information) and position information related to the motion data via the network 40, and preserves the swing analysis data. Therefore, when the user 2 performs a swing action according to the procedures illustrated in FIG. 4, the swing analysis data generated by the swing analysis device 20 is preserved in the swing diagnosis device 30, and thus a swing analysis data list is built.

The information processing device 50 functions as a storage region storing motion data of the user 2 and position information related to the motion data, and receives the swing analysis data transmitted by the swing analysis device 20 and including motion data (swing information including swing analysis information as motion analysis information) and position information related to the motion data via the network 40, and preserves the swing analysis data.

In the present embodiment, if the user 2 activates a swing diagnosis application via an operation section 23 (refer to FIG. 6) of the swing analysis device 20, the swing analysis device 20 performs communication with the swing diagnosis device 30, and, for example, a selection screen (not illustrated) of swing analysis data is displayed on a display 25 (refer to FIG. 6) of the swing analysis device 20. The selection screen includes a time point (date and time), the type of golf club which has been used, and some index values as analysis results of a swing, with respect to each item of swing analysis data regarding the user 2 included in the swing analysis data list preserved in the swing diagnosis device 30.

A checkbox correlated with each item of swing analysis data is located on the selection screen, and the user 2 checks any one of the checkboxes by operating the swing analysis device 20. Consequently, the swing analysis device 20 performs communication with the swing diagnosis device 30, and, thus, for example, an editing screen of input data which is a swing diagnosis target is displayed on the display 25 of the swing analysis device 20, with respect to the swing analysis data correlated with the checked checkbox on the selection screen. The input data editing screen includes values obtained on the basis of the selected swing analysis data as initial values with respect to the sex, a golf level, the type of golf club (either of a driver or an iron), and each index of a swing.

The input data formed of the sex, the golf level, the type of golf club, and the respective index values in the input data editing screen can be edited. The user 2 may edit the input data via the operation section 23 (refer to FIG. 6) of the swing analysis device 20. The user 2 inputs, for example, a golf score for each hole as input data from the input data editing screen. Consequently, the swing analysis device 20 transmits the input data to the swing diagnosis device 30.

The swing diagnosis device 30 receives the input data (input result), and calculates levels of a plurality of items by using the input data. For example, the swing diagnosis device 30 may analyze each of items such as a “V zone”, “rotation”, “impact”, a “swing tempo”, and “swing efficiency”, so as to calculate a level thereof or generate evaluation information.

The swing analysis device 20 receives the levels and the evaluation information of the plurality of items, and displays, for example, a swing diagnosis screen on the display 25. The user 2 can understand levels and a total score of the plurality of items as diagnosis results on the basis of the swing diagnosis screen.

### 1-2. Configurations of Sensor Unit and Swing Analysis Device

FIG. 6 is a diagram illustrating configuration examples of the sensor unit 10 and the swing analysis device 20. As illustrated in FIG. 6, the sensor unit 10 is configured to include an acceleration sensor 12, an angular velocity sensor 14, a signal processing section 16, and a communication section 18. However, the sensor unit 10 may have a configuration in which some of the constituent elements are deleted or changed as appropriate, or may have a configuration in which other constituent elements are added thereto.

The acceleration sensor 12 as an inertial sensor measures respective accelerations in three axial directions which intersect (ideally, orthogonal to) each other, and outputs digital signals (acceleration data) corresponding to magnitudes and directions of the measured three-axis accelerations.

The angular velocity sensor 14 as an inertial sensor measures respective angular velocities in three axial directions which intersect (ideally, orthogonal to) each other, and outputs digital signals (angular velocity data) corresponding to magnitudes and directions of the measured angular velocities in the three axial directions.

The signal processing section 16 receives the acceleration data and the angular velocity data from the acceleration sensor 12 and the angular velocity sensor 14, respectively, adds time information thereto, stores the data in a storage portion (not illustrated), adds time information to the stored measured data (acceleration data and angular velocity data) so as to generate packet data conforming to a communication format, and outputs the packet data to the communication section 18.

Ideally, the acceleration sensor 12 and the angular velocity sensor 14 are provided in the sensor unit 10 so that the three axes thereof match three axes (an x axis, a y axis, and a z axis) of an orthogonal coordinate system (sensor coordinate system) defined for the sensor unit 10, but, actually, errors occur in installation angles. Therefore, the signal processing section 16 performs a process of converting the acceleration data and the angular velocity data into data in the xyz coordinate system by using a correction parameter which is calculated in advance according to the installation angle errors.

The communication section 18 performs a process of transmitting packet data received from the signal processing section 16 to the swing analysis device 20, or a process of receiving a control command from the swing analysis device 20 and sending the control command to the signal processing section 16. The signal processing section 16 performs various processes corresponding to control commands.

The swing analysis device 20 is configured to include a processor 21, a communication section 22, an operation section 23, a storage 24, a display 25, a sound output section 26, a communication section 27, and a position information acquisition section 43. However, the swing analysis device 20 may have a configuration in which some of the constituent elements are deleted or changed as appropriate, or may have a configuration in which other constituent elements are added thereto.

The communication section 22 performs a process of receiving packet data transmitted from the sensor unit 10 and sending the packet data to the processor 21, or a process of transmitting a control command from the processor 21 to the sensor unit 10. The communication section 22 performs a process of receiving course information including course arrangement or the like in a golf course via the network 40.

The operation section 23 performs a process of acquiring operation data from the user 2 and sending the operation data to the processor 21. The operation section 23 may be, for example, a touch panel type display, a button, a key, or a microphone.

The storage 24 is constituted of, for example, various IC memories such as a read only memory (ROM), a flash ROM, and a random access memory (RAM), or a recording medium such as a hard disk or a memory card. The storage 24 stores a program for the processor 21 performing various calculation processes or a control process, or various programs or data for realizing application functions.

In the present embodiment, the storage 24 stores a swing analysis program 240 which is read by the processor 21, and causes a computer to execute steps of acquiring position information of the user 2, searching for past motion data in a predetermined position range on the basis of the acquired position information, and outputting a tendency of the extracted past motion data. The swing analysis program 240 may be stored in a nonvolatile recording medium (computer readable recording medium) in advance, or the swing analysis program 240 may be received from a server (not illustrated) or the swing diagnosis device 30 by the processor 21 via the network 40, and may be stored in the storage 24.

In the present embodiment, the storage 24 stores golf club information 242, physical information 244, sensor attachment position information 246, golf course information 247, and swing analysis data 248. For example, the user 2 may operate the operation section 23 so as to input specification information regarding the golf club 3 (for example, at least some information such as information regarding a length of the shaft, a position of the centroid thereof, a lie angle, a face age, a loft angle, and the like) from the input screen, and the input specification information may be used as the golf club information 242. Alternatively, in step S1 in FIG. 4, the user 2 may sequentially input type numbers of the golf club 3 (alternatively, selects a type number from a type number list) so that specification information for each type number is stored in the storage 24 in advance. In this case, specification information of an input type number may be used as the golf club information 242. The storage 24 may store a golf level (not illustrated) of the user 2.

For example, the user 2 may input physical information by operating the operation section 23 from the input screen, and the input physical information may be used as the physical information 244. For example, in step S1 in FIG. 4, the user 2 may input an attachment position of the sensor unit 10 and a distance to the grip end of the golf club 3 by operating the operation section 23, and the input distance information may be used as the sensor attachment position information 246. Alternatively, the sensor unit 10 may be attached at a defined predetermined position (for example, a distance of 20 cm from the grip end), and thus information regarding the predetermined position may be stored as the sensor attachment position information 246 in advance. The user 2 may operate the operation section 23, and may store information regarding a golf course in which the user 2 will play golf as the golf course information 247 in advance via the network 40.

The swing analysis data 248 is data including information regarding a swing action analysis result in the processor 21 (swing analysis portion 211) along with a time point (date and time) at which a swing was performed, identification information or the sex of the user 2, and the type of golf club 3.

The storage 24 is used as a work region of the processor 21, and temporarily stores data which is input from the operation section 23, results of calculation executed by the processor 21 according to various programs, and the like. The storage 24 may store data which is required to be preserved for a long period of time among data items generated through processing of the processor 21.

The display 25 displays a processing result in the processor 21 as text, a graph, a table, animation, and other images. The display 25 may be, for example, a CRT, an LCD, a touch panel type display, and a head mounted display (HMD). A single touch panel type display may realize functions of the operation section 23 and the display 25.

The analysis information displayed on the display 25 preferably includes information related to at least one of impact based on a relative face angle and a club path (incidence angle); efficiency based on an deceleration amount and timing in the grip of the golf club 3; a rotation angle of the shaft axis and a face angle at top; a head speed based on a speed of the golf club 3 at ball hitting; and a swing tempo based on address starting, swing starting, and top and impact timings. Analysis data of an important index indicating ability (level) regarding a plurality of swings is not limited thereto, and may include indexes such as hands-up based on lie angles at ball hitting and at address, and a down blow based on a face angle and an attack angle.

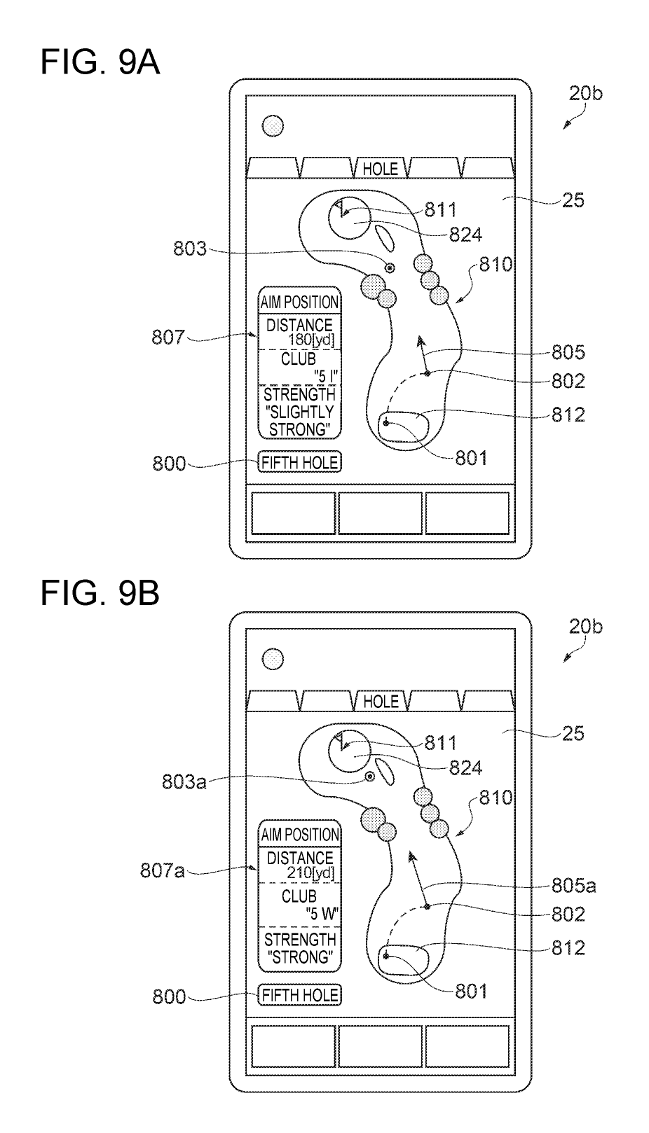

The display 25 displays, for example, images as shown in display examples 1 and 2 in FIGS. 9A and 9B. Detailed description of display examples will be made later, and thus description thereof will be omitted. Regarding a function of the operation section 23 in the display 25, the display content can be switched or enlarged or reduced by touching (screen touching) the display 25.

The sound output section 26 outputs a processing result (analysis information) in the processor 21 so as to present the processing result as a sound such as a voice or a buzzer sound. The sound output section 26 may be, for example, a speaker or a buzzer.

The communication section 27 performs data communication with a communication section (not illustrated) of the swing diagnosis device 30 via the network 40. For example, the communication section 27 performs a process of receiving the swing analysis data 248 from the processor 21 after a swing analysis process is completed, and transmitting the swing analysis data to the communication section of the swing diagnosis device 30. For example, the communication section 27 performs a process of receiving information required to display a selection screen from the communication section of the swing diagnosis device 30 and transmitting the information to the processor 21, and a process of receiving selected information on the selection screen from the processor 21 and transmitting the selected information to the communication section of the swing diagnosis device 30. For example, the communication section 27 performs a process of receiving information required to display an input data editing screen from the communication section of the swing diagnosis device 30, and transmitting the information to the processor 21. For example, the communication section 27 performs a process of receiving input data at the time of pressing a diagnosis starting button on the input data editing screen from the processor 21, and transmitting the input data to the communication section of the swing diagnosis device 30. For example, the communication section 27 performs a process of receiving information required to display a swing diagnosis screen from the communication section of the swing diagnosis device 30, and transmitting the information to the processor 21.

The processor 21 performs a process of transmitting a control command to the sensor unit 10 via the communication section 22, or various computation processes on data which is received from the sensor unit 10 via the communication section 22, according to various programs. The processor 21 performs a process of reading the swing analysis data 248 from the storage 24, and transmitting the swing analysis data to the swing diagnosis device 30 via the communication section 27, according to various programs. In the processor 21, a swing analysis portion 211 detects a swing deviated from a predetermined range among numerical values obtained by generating motion states as numerical values with respect to a plurality of golf swings in a processor (not illustrated) of the swing diagnosis device 30 which will be described later, and obtains play states indicating actual states, advantages, and weaknesses of actions including golf swings or movement of the user 2 on the basis of detection results in a plurality of swings. The processor 21 may output the obtained play states of the user 2 as image data corresponding to images indicating the play states.

The processor 21 may store a course arrangement in a golf course, an elevation, or the like which is input via the communication section 22 in the storage 24 as the golf course information 247. The processor 21 calculates position information of the user 2 on the basis of the current position data sent from the position information acquisition section 43 which will be described later. The position information includes information regarding a movement path or a movement time (staying time) of the user 2 in a course. The processor 21 may output play states of the user as image data corresponding to images indicating the play states on the basis of the calculated position information of the user 2 and the detection results in a plurality of swings. As mentioned above, the play states are output along with the calculated position information of the user 2, and detection results of motion states in golf swings, and thus a finer play state can be output than in a case where a movement state or the like of the user 2 is included. The processor 21 performs other various control processes.

By executing the swing analysis program 240, the processor 21 functions as a data acquisition portion 210, a swing analysis portion 211, an image data generation portion 212, a storage processing portion 213, a display processing portion 214, and a sound output processing portion 215. The processor 21 functions as a computer.

Particularly, in the present embodiment, by executing the swing analysis program 240, the processor 21 functions as the data acquisition portion 210, the swing analysis portion 211, the image data generation portion 212, the storage processing portion 213, the display processing portion 214, and the sound output processing portion 215, and performs a process (swing analysis process) of analyzing a swing action of the user 2, and a process of obtaining and outputting position information including a movement or the like of the user 2 and a tendency of the past motion data at the current position of the user 2.

The data acquisition portion 210 performs a process of receiving packet data which is received from the sensor unit 10 by the communication section 22, acquiring time information and measured data in the sensor unit 10 from the received packet data, and sending the time information and the measured data to the storage processing portion 213. The data acquisition portion 210 performs a process of searching for the past motion data (swing information as motion analysis information) in a predetermined position range from the information processing device 50 storing the past motion data on the basis of the acquired position information of the user 2, and extracting the past motion data (swing information) which is a target. The data acquisition portion 210 performs a process of receiving the information required to display various screens, received from the swing diagnosis device 30 by the communication section 27, or generating information indicating the tendency of the extracted past motion data, and transmitting the information to the image data generation portion 212.

The storage processing portion 213 performs read/write processes of various programs or various data for the storage 24. The storage processing portion 213 performs a process of storing the time information and the measured data received from the data acquisition portion 210 in the storage 24 in correlation with each other, or a process of storing various pieces of information calculated by the swing analysis portion 211, the swing analysis data 248, or the like in the storage 24.

The swing analysis portion 211 performs a process of analyzing a swing action of the user 2 by using the measured data (the measured data stored in the storage 24 or the information processing device 50 (refer to FIG. 1)) output from the sensor unit 10, input which is input from the operation section 23, or the like, so as to generate the swing analysis data 248 including a time point (date and time) at which the swing was performed, identification information or the sex of the user 2, the type of golf club 3, and information regarding a swing action analysis result. Particularly, in the present embodiment, the swing analysis portion 211 calculates a value of each index of the swing as at least some of the information regarding the swing action analysis result. The swing analysis data 248 includes information regarding at least one of the impact, the V zone, the efficiency (swing efficiency), the rotation, the head speed, and the swing tempo.

### 1-3. Data Analysis Method

The motion data of the user 2 which is calculated as described above and is stored in a storage region such as the information processing device 50 (refer to FIG. 1), and the tendency of the past motion data retrieved on the basis of position information related to the motion data are output, and thus the user 2 can obtain analysis information including information indicating a general tendency of the past motion data related to the current position. Consequently, the user 2 can perform a motion while making a strategy on the basis of information indicating the general tendency, and can thus obtain an analysis result (advice information) which is more satisfactory.

As will be described below, the motion data may be used as motion analysis information related to golf, and thus the position data is preferably used as position information related to a round of golf. As mentioned above, since the motion data is used as motion analysis information related to golf, and the position data is used as position information related to a round of golf, a tendency of the past motion analysis information in a predetermined position range which is retrieved and extracted from motion analysis information (golf swing analysis data) accumulated in the storage region is output on the basis of position information of the user 2 related to a round of golf. Consequently, it is possible to present advice information including information indicating a general tendency of the past motion analysis information related to the current position at the time of a shot at the current round position (current position) of the user 2, to the user 2. Therefore, the user 2 can perform rounding while making a strategy on the basis of the advice information indicating the general tendency, and can obtain an analysis result (advice information) related to a golf swing, which is more satisfactory.

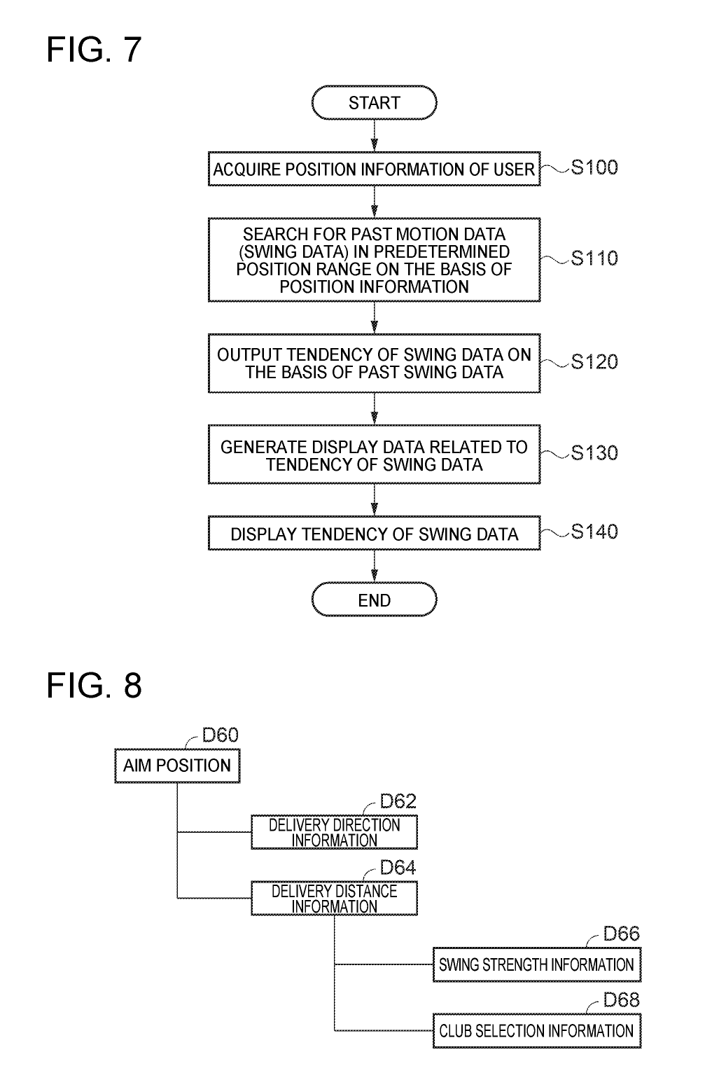

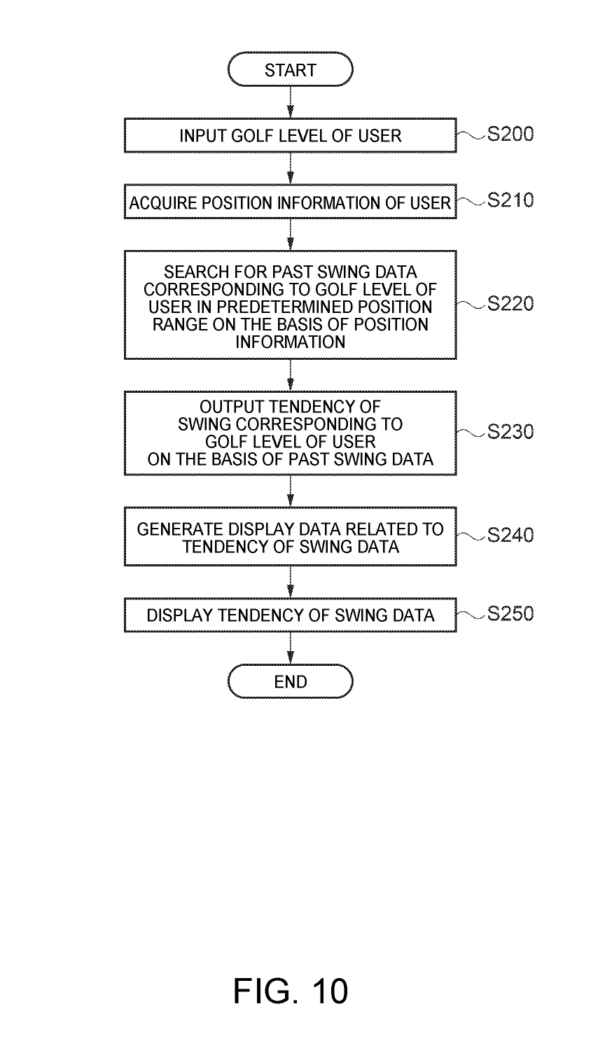

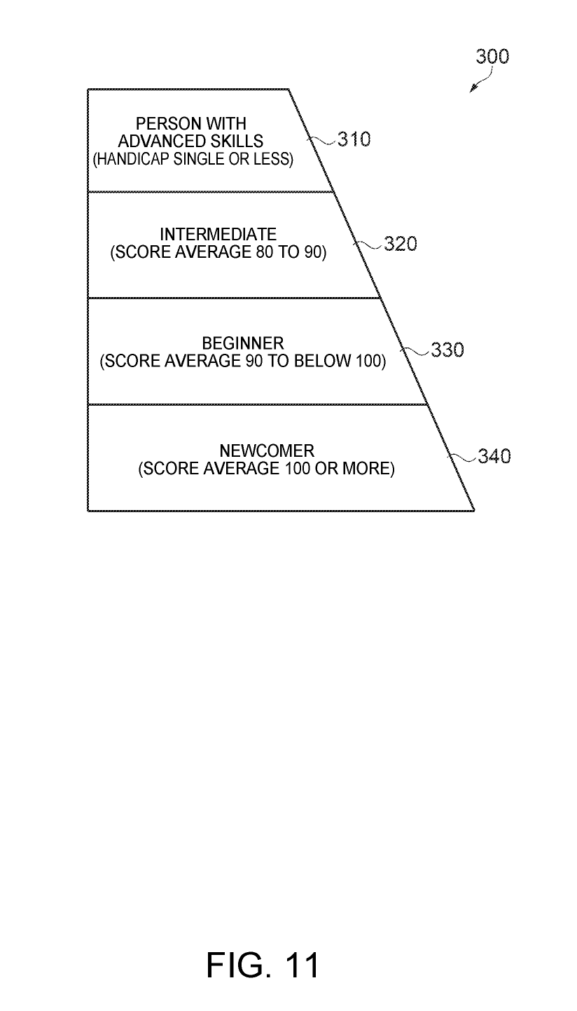

The data processing method will be described in detail with reference to FIGS. 7, 8, 9A, 9B, 10 and 11 by exemplifying a motion analysis method related to golf. FIG. 7 is a flowchart illustrating steps related to Embodiment 1 of a data processing method in the motion analysis system. FIG. 8 is a block diagram for explaining advice items regarding a tendency of the past motion data. FIGS. 9A and 9B are diagrams illustrating an advice display example of giving advice on a tendency of the past motion data related to the current position, in which FIG. 9A illustrates a display example 1, and FIG. 9B illustrates a display example 2. FIG. 10 is a flowchart illustrating steps related to Embodiment 2 of a data processing method in the motion analysis system. FIG. 11 is a diagram illustrating a classification example of a golf level.

### Embodiment 1

Hereinafter, with respect to the flowchart in FIG. 7, a description will be made of Embodiment 1 of a swing analysis method (motion analysis method related to golf) according to the present embodiment. Hereinafter, the constituent elements described above are given the same reference numerals, and will be described.

Prior to steps illustrated in the flowchart in FIG. 7, although not illustrated in the flowchart, the user 2 selects a golf course for playing golf in advance, acquires course information regarding the golf course, and performs a swing for a first shot.

The user 2 finishing the swing for the first shot and reaching a second shot position operates the operation section 23 so as to acquire second shot position information with the position information acquisition section 43 (step S100). The acquired second shot position information is transmitted to the processor 21.

Next, the data acquisition portion 210 of the processor 21 searches for the past motion data (swing analysis as motion analysis information; hereinafter, referred to as “swing data”) in a predetermined position range (in this example, a position range set for the second shot position) set in advance from the information processing device 50 on the basis of the acquired second shot position information (step S110), and extracts target past swing data. The past swing data extracted here is a swing data group (motion data group) of data analyzed on the basis of a plurality of swings.

Next, the data acquisition portion 210 of the processor 21 generates information regarding a tendency of the past swing data on the basis of the extracted past swing data (swing data group), and outputs the information to the image data generation portion 212 as advice information indicating the tendency of the past swing data related to the second shot (step S120). Here, the advice information obtained on the basis of the tendency of the swing data may include at least one of, for example, as illustrated in FIG. 8, an aim position D60 as a desired ball landing position (standing still position) at the second shot, target direction information D62 (target direction) or target distance information D64 (a carry of a hit ball) related to the aim position D60, and swing strength information D66 or club selection information D68 (golf club information) related to the target distance information D64. The club selection information D68 and the priority of advice information may be output in correlation with each other on the basis of whether or not a swing is successful for each club.

Since advice information is obtained on the basis of a tendency of swing data, the user 2 can obtain at least any of a carry of a hit ball, a target direction, and golf club information in golf as a tendency of motion data, and can thus obtain more detailed and accurate advice information of a swing at the current position. In a case where an amount of the past swing data is small, or in response to a user's request (desire of specific swing data), the past swing data may be output to the image data generation portion 212 as advice information.

Next, the image data generation portion 212 of the processor 21 generates display data for displaying advice information indicating a tendency of the past swing data of a swing related to the second shot (step S130).

Next, the processor 21 sends the display data indicating the advice information indicating the tendency of the past swing data of the swing related to the second shot and the second shot position, generated in step S130, to the display 25, displays the display data as image information which will be described later, illustrated in FIG. 9A or 9B (step S140), and finishes a series of processes.

Advice information to be displayed may be formed, for example, as a plurality of pieces of advice information as in the display example 1 and the display example 2 which will be described later, and the user 2 may select and execute advice information suitable for a situation of the user from among the plurality of pieces of advice information. In the flowchart illustrated in FIG. 7, an order of the respective steps may be changed within an allowable range. As illustrated in FIG. 9A or 9B, the advice information may be displayed along with course information.

Here, with reference to FIGS. 9A and 9B, the display example 1 representing first advice information and the display example 2 representing second advice information will be described as a plurality of pieces of advice information indicating a tendency of the past swing data of a swing related to the second shot and a second shot position. The user 2 having obtained the plurality of pieces of advice information may select and execute advice information suitable for the current state of the user.

In the display example 1 as the first advice information, FIG. 9A illustrates a case where a fifth hole is selected as a hole for which a detailed analysis result is desired to be known. In the display example 1, a hole name (fifth hole) 800, a hole summary 810 shown in a hole diagram, a shot position which is a hitting position at each shot, an arrow 805 indicating a desired target direction, a position 803 indicating an aim position of a hit ball at the second shot, a window display 807 indicating details of the aim position are displayed on the display 25.

Specifically, in the display example 1, as a hitting position at each shot, a tee shot position 801 as a hitting position at the first shot in a tee ground 812, and a second shot position 802 as a hitting position at the second shot are displayed. The tee shot position 801 and the second shot position 802 may be obtained on the basis of the acquired position information. A green 824 including a pin mark 811 indicating a cup position as position information is displayed.

A distance (in this example, 180 yards (“180 [yd]”)) from the second shot position 802 to the aim position 803 which is a landing position (standing still position) as an aimed location of a hit ball, the type of club (in this example, a mark of “5I” indicating a 5-iron) selected for the second shot, and the strength (in this example, “slightly strong” indicating a strong swing) at the second shot are displayed on the window display 807 in the display example 1.

In the display example 2 as the second advice information, FIG. 9B illustrates an example in which an aim position of a hit ball is changed as advice information which is different from the first advice information. In the display example 2, a hole name (fifth hole) 800, a hole summary 810 shown in a hole diagram, a shot position (a tee shot position 801 and a second shot position 802) which is a hitting position at each shot, an arrow 805a indicating a desired target direction, a position 803a indicating an aim position of a hit ball at the second shot, a window display 807a indicating details of the aim position are displayed on the display 25. The hole name 800, the hole summary 810, the shot position (the tee shot position 801 in the tee ground 812 and the second shot position 802) which is a hitting position at each shot are the same as those in the display example 1. A green 824 including a pin mark 811 indicating a cup position is the same as that in the display example 1.

Specifically, a distance (in this example, 210 yards (“210 [yd]”)) from the second shot position 802 to the aim position 803a which is a landing position (standing still position) as an aimed location of a hit ball, the type of club (in this example, a mark of “5W” indicating a 5-wood (cleek)) selected for the second shot, and the strength (in this example, “strong” indicating a strong swing) at the second shot are displayed on the window display 807a in the display example 2.

In the display example 1 of the first advice information and the display example 2 of the second advice information, the past swing data obtained on the basis of information regarding the second shot position may be retrieved, and, for example, two of large tendency groups may be selected and displayed on the basis of tendencies of a plurality of extracted past swing data.

The advice information may be displayed to be added with priority on the basis of a tendency of the past swing data. For example, the display example 1 may be displayed to be added with higher priority than that of the display example 2. Specifically, the image information illustrated in FIG. 9A may be displayed by adding text information such as a recommendation degree “high”, and the image information illustrated in FIG. 9B may be displayed by adding text information such as a recommendation degree “intermediate”.

Each of the arrows 805 and 805a for teaching desired target directions at the second shot is indicated by a base line part and an arrow head part based on a tendency of the past swing data. The base line part of the arrow may be made large so as to have a large width in the target direction.

According to the display method, it is possible to present, to the user 2, advice information (for example, the display example 1 or the display example 2) including information indicating a general tendency of the past motion analysis information related to the current shot position during a shot in a round of the user 2. Therefore, the user 2 can perform rounding while making a strategy on the basis of the advice information indicating the general tendency, and can thus obtain an analysis result (advice information) related to a golf swing, which is more satisfactory.

According to the data processing method according to Embodiment 1, a tendency of the past swing data in a predetermined position range (in this example, a position range set for the second shot position) retrieved and extracted from swing data (motion information including position information related to the swing data) stored and accumulated in the storage region (information processing device 50) is output on the basis of the second shot position which is position information of the user 2. Consequently, analysis information including information indicating a general tendency of the past swing data related to the current position in a swing (shot) at the current position of the user 2 can be presented to the user 2 as image information, for example, on the display 25. Therefore, the user 2 can perform a swing while making a strategy on the basis of information indicating the general tendency, and can thus obtain an analysis result (advice information) which is more satisfactory.

### Embodiment 2

Hereinafter, with reference to a flowchart in FIG. 10, a description will be made of Embodiment 2 of a data processing method in the same analysis system according to the present embodiment. Hereinafter, the constituent elements of the motion analysis system described above are given the same reference numerals, and will be described.

First, prior to steps illustrated in the flowchart in FIG. 10, although not illustrated in the flowchart, the user 2 selects a golf course for playing golf in advance, and acquires course information regarding the golf course.

In the flowchart in FIG. 10, the user 2 selects a golf level (for example, “intermediate level”) and inputs the level (S200). Then, the user 2 performs a tee shot swing as a first shot.

The golf level here may be expressed as the ability of a player classified on the basis of, for example, a score level. Regarding a classification example of a golf level, as in a classification example 300 illustrated in FIG. 11, for example, a level may be classified as follows. For example, a person of which a handicap is equal to or less than a single is classified as a person with advanced skills 310, a person of which a score average is 80 to 90 is classified as an intermediate 320, a person of which a score average is 90 to below 100 is classified as a beginner 330, and a person of which a score average is equal to or more than 100 is classified as a newcomer 340. A golf level may be classified not only according to the ability of a player classified on the basis of a score level but also according to information regarding the age or physique of a player, and swing data (a carry or the like).

The user 2 finishing the swing for the first shot and reaching a second shot position operates the operation section 23 so as to acquire second shot position information with the position information acquisition section 43 (step S210). The acquired second shot position information is transmitted to the processor 21.

Next, the data acquisition portion 210 of the processor 21 searches for the past motion data (swing analysis as motion analysis information; hereinafter, referred to as “swing data”) in a predetermined position range set in advance from the information processing device 50 on the basis of the acquired second shot position information (step S220), and extracts target past swing data corresponding to the golf level of the user 2. In other words, the past swing data in the same extent of golf level as that of the user 2 is extracted. The past swing data extracted here is a swing data group (motion data group) of data analyzed on the basis of a plurality of swings.

Next, the data acquisition portion 210 of the processor 21 generates information regarding a tendency of the past swing data on the basis of the extracted past swing data (swing data group), and outputs the information to the image data generation portion 212 as advice information indicating the tendency of the past swing data related to the second shot corresponding to the golf level of the user 2 (step S230). Here, the advice information obtained on the basis of the tendency of the swing data is the same as that described in Embodiment 1 with reference to FIG. 8, and thus description thereof will be omitted here.

Next, the image data generation portion 212 of the processor 21 generates display data for displaying advice information indicating a tendency of the past swing data of a swing related to the second shot corresponding to the golf level of the user 2 (step S240).

Next, the processor 21 sends the display data indicating the advice information indicating the tendency of the past swing data, corresponding to the golf level of the user 2, of the swing related to the second shot and the second shot position, generated in step S240, to the display 25, displays the display data as image information which will be described later, illustrated in FIG. 9A or 9B (step S250) in Embodiment 1, and finishes a series of processes.

Advice information to be displayed may be formed, for example, as a plurality of pieces of advice information as in the display example 1 and the display example 2 which will be described later, and the user 2 may select and execute advice information suitable for a situation of the user from among the plurality of pieces of advice information. In the flowchart illustrated in FIG. 10, an order of the respective steps may be changed within an allowable range.

According to the data processing method according to Embodiment 2, the user 2 can obtain a tendency of motion analysis information corresponding to the same extent of golf ability level as that of the user 2. In other words, the user 2 can obtain a more accurate analysis result (advice information) related to a golf swing, suitable for the golf level of the user 2.

Swing data as motion data may employ swing data of a plurality of different users. In a case where a tendency of the past swing data in a predetermined position range is output on the basis of the stored swing data of the plurality of different users, it is possible to increase the reliability of analysis information including information indicating a general tendency of the past swing data related to the current position presented to the user 2.

The motion data stored in the information processing device 50 may include measured data (including raw data) measured by the sensor unit 10 or motion data (swing information as motion analysis information) of the user 2 analyzed by the swing analysis device 20.

For example, the invention includes substantially the same configuration (for example, a configuration in which functions, methods, and results are the same, or a configuration in which objects and effects are the same) as the configuration described in the embodiment. The invention includes a configuration in which an inessential part of the configuration described in the embodiment is replaced with another part. The invention includes a configuration which achieves the same operation and effect or a configuration capable of achieving the same object as in the configuration described in the embodiment. The invention includes a configuration in which a well-known technique is added to the configuration described in the embodiment.

What is claimed is:

1. A data processing method in a motion analysis system including a storage region storing motion data of a user and position information related to the motion data, the data processing method comprising:
acquiring position information of the user;
searching for past motion data in a predetermined position range on the basis of the acquired position information; and
outputting advice information on the basis of the past motion data.

2. The data processing method according to claim 1,
wherein the motion data is motion data of a plurality of different users.

3. The data processing method according to claim 1,
wherein the motion data is motion analysis information related to golf, and
wherein the position information is position data related to a round of golf.

4. The data processing method according to claim 3, further comprising:
receiving a golf level,
wherein, in the outputting of the advice information, a tendency of the motion analysis information corresponding to the golf level is output.

5. The data processing method according to claim 3,
wherein the advice information is related to at least one of a carry of a hit ball, a target direction, and golf club information in golf.

6. A non-transitory computer readable medium storing a program related to data processing in a motion analysis system including a storage region storing motion data of a user and position information related to the motion data, the program causing a computer to execute:
acquiring position information of the user;
searching for past motion data in a predetermined position range on the basis of the acquired position information; and
outputting advice information on the basis of the past motion data.

7. A motion analysis system comprising:
a storage region storing motion data of a user and position information related to the motion data;
a swing analyzing device configured with a processor, the swing analyzing device programmed to act as the following:
the swing analyzing device acquiring position information of the user;
the processor searching for past motion data in a predetermined position range on the basis of the acquired position information; and
outputting advice information on the basis of the past motion data.
